(19) United States
(12) Patent Application Publication
(10) Pub. No.: US 2008/0201736 A1
(43) Pub. Date: Aug. 21, 2008

(54) Using Triggers with Video for Interactive Content Identification

(75) Inventors: Donald Gordon, Mountain View, CA (US); Lena Y. Pavlovskaia, Cupertino, CA (US); Airan Landau, San Jose, CA (US); Edward Ludvig, Redwood City, CA (US); Gregory E. Brown, Fremont, CA (US)

Correspondence Address: BROMBERG & SUNSTEIN LLP, 125 SUMMER STREET, BOSTON, MA, 02110-1618, US

(73) Assignee: ICTV, INC., San Jose, CA (US)

(21) Appl. No.: 12/035,236

(22) Filed: Feb. 21, 2008

Related U.S. Application Data
(63) Continuation-in-part of application No. 12/008,722, filed on Jan. 11, 2008.
Application No. 12/008,722 is a continuation-in-part of application No. 12/008,697, filed on Jan. 11, 2008.
(60) Provisional application No. 60/884,773, filed on Jan. 12, 2007.
(60) Provisional application No. 60/884,744, filed on Jan. 12, 2007.
(60) Provisional application No. 60/884,772, filed on Jan. 12, 2007.
(60) Provisional application No. 60/884,773, filed on Jan. 12, 2007.
(60) Provisional application No. 60/884,744, filed on Jan. 12, 2007.
(60) Provisional application No. 60/884,772, filed on Jan. 12, 2007.

(51) Int. Cl. H04N 7/025; H04N 5/445; H04N 7/173

(52) U.S. Cl. 725/34; 725/32; 725/60; 725/93

(57) ABSTRACT

Access to interactive content at a client device through the use of triggers is disclosed. The client device is coupled to a television communication network and receives an encoded broadcast video stream containing at least one trigger. The client device decodes the encoded broadcast video stream and parses the broadcast video stream for triggers. As the broadcast video stream is parsed, the stream is output to a display device. When a trigger is identified, the client device automatically tunes to an interactive content channel. The client device sends a signal indicative of the trigger through the television communication network to the processing office. The processing office can then use the information contained within the trigger signal to provide content to the client device. The content may be interactive content, static content, or the broadcast program stitched with interactive or static content. The user of the client device can then interact with any interactive content.

### PRIORITY

The present U.S. patent application is a Continuation-In-Part of and claims priority from U.S. patent application Ser. No. 12/008,722 entitled “MPEG Objects and Systems and Methods for Using MPEG Objects” filed on Jan. 11, 2008, which itself claims priority from U.S. Provisional Patent Applications No. 60/884,744, No. 60/884,772, and No. 60/884,773, each of which was filed on Jan. 12, 2007. The subject matter of these applications is incorporated herein by reference in their entirety. The present U.S. patent application is also a Continuation-In-Part of and claims priority from U.S. patent application Ser. No. 12/008,697 entitled “Interactive Encoded Content System including Object Models for Viewing on a Remote Device” filed on Jan. 11, 2008, which itself claims priority from U.S. Provisional Patent Applications No. 60/884,744, No. 60/884,772, and No. 60/884,773, each of which was filed on Jan. 12, 2007. The subject matter of these applications is incorporated herein by reference in their entirety.

### TECHNICAL FIELD AND BACKGROUND ART

The present invention relates to interactive encoded video and more specifically to interactive MPEG video that can be used with a client device having a decoder and limited caching capabilities.

Set-top boxes of cable television systems have preferably been simple devices. The boxes generally include a QAM decoder, an MPEG decoder, and a transceiver for receiving signals from a remote control and transferring the signals to the cable headend. In order to keep costs down, set-top boxes have not included sophisticated processors, such as those found in personal computers or extensive memory for caching content or programs. As a result, developers attempting to provide interactive content that includes encoded video elements such as those found in dynamic web pages to subscribers have been forced to find solutions that are compatible with the set-top boxes. These solutions require having the processing functionality reside at the cable headend and further require that the content is delivered in MPEG format. In order to provide dynamic web page content, the content forming the web page first must be decoded and then rendered within the webpage frame as a bitmap. Next, the rendered frames are then re-encoded into an MPEG stream that the set-top box of a requesting user can decode. This decoding and re-encoding scheme is processor intensive.

Similar to the problems encountered by content providers for cable television, content providers that wish to produce interactive content on cell phones have been limited by cell phone hardware. The content providers have been forced to create multiple versions of the content because of the various hardware and software discrepancies between cell phone platforms.

Triggers have been used with television programs to indicate insertion points for advertisements. With analog television signals, the triggers were placed out of band. In the digital era, protocols have been developed for trigger insertion. For example, ANSI has developed a standard for use with digital transmissions SCTE-35 that provides a mechanism for cable head ends to identify locations within a digital broadcast for insertion of a local advertisement.

### SUMMARY OF THE INVENTION

In a first embodiment, a system for providing interactive MPEG content for display on a display device associated with a client device having an MPEG decoder is disclosed. The system operates in a client/server environment wherein the server includes a plurality of session processors that can be assigned to an interactive session requested by a client device. The session processor runs a virtual machine, such as a JAVA virtual machine. The virtual machine includes code that in response to a request for an application accesses the requested application. In addition the virtual machine is capable of parsing the application and interpreting scripts. The application contains a layout for an MPEG frame composed of a plurality of MPEG elements. The application also includes a script that refers to one or more MPEG objects that provide the interactive functionality and the MPEG elements (MPEG encoded audio/video) or methodology for accessing the encoded MPEG audio/video content if the content is stored external to the MPEG object.

The MPEG object includes an object interface that defines data received by the MPEG object and data output by the MPEG object. Additionally, the MPEG object includes one or more MPEG video or audio elements. The MPEG elements are preferably groomed so that the elements can be stitched together to form an MPEG video frame. In some embodiments, the MPEG elements are located external to the MPEG object and the MPEG object includes a method for accessing the MPEG element(s). In certain embodiments, the MPEG object includes a plurality of MPEG video elements wherein each element represents a different state for the MPEG object. For example, a button may have an “on” state and an “off” state and an MPEG button object would include an MPEG element composed of a plurality of macroblocks/slices for each state. The MPEG object also includes methods for receiving input from the client device through the object interface and for outputting data from the MPEG object through the object interface.

After the program running on the virtual machine, has obtained all of the MPEG objects indicated in the application, the program on the virtual machine provides the MPEG elements and the layout to a stitcher. In certain embodiments, the virtual machine and program for retrieving and parsing the application and interpreting the scripts may be subsumed in the stitcher. The stitcher then stitches together each of the MPEG elements in their position within the MPEG frame. The stitched MPEG video frame is passed to a multiplexor that multiplexes in any MPEG audio content and additional data streams and the MPEG video frame is placed into an MPEG transport stream that is directed to the client device. In certain embodiments, the multiplexor may be internal to the stitcher. The client device receives the MPEG frame and can then decode and display the video frame on an associated display device. This process repeats for each video frame that is sent to the client device. As the client interacts and makes requests, for example changing the state of a button object, the virtual machine in conjunction with the MPEG object updates the MPEG element provided to the stitcher and the stitcher will replace the MPEG element within the MPEG video frame based upon the request of the client device. In certain other embodiments, each MPEG element representative of a different state of the MPEG object is provided to the stitcher. The virtual machine forwards the client's request to the stitcher and the stitcher selects the appropriate MPEG element based upon the MPEG objects state from a buffer to stitch into the MPEG video frame.

An interactive MPEG application may be constructed in an authoring environment. The authoring environment includes an editor with one or more scene windows that allow a user to create a scene based upon placement of MPEG objects within a scene window. An object tool bar is included within the authoring environment that allows the MPEG objects to be added. The authoring environment also includes a processor that produces an application file that contains at least reference to the MPEG objects and the display position for each of the MPEG objects within the scene. Preferably, when the MPEG object is placed within a scene window, the MPEG video element for the MPEG object is automatically snapped to a macroblock boundary. For each MPEG object that is added to the scene, the properties for the object can be modified. The authoring environment also allows a programmer to create scripts for using the MPEG objects. For example, a script within the application may relate a button state to an execution of a program. The authoring environment also provides for the creation of new MPEG objects. A designer may create an MPEG object by providing graphical content such as a video file or still image. The authoring environment will encode the graphical content so that the content includes MPEG elements/slices or a sequence of MPEG elements/slices. In addition to defining the MPEG video resource, the authoring environment allows the designer to add methods, properties, object data and scripts to the MPEG object.

In further embodiments, access to interactive content at a client device is provided through the use of triggers. The client device is coupled to a television communication network and receives an encoded broadcast video stream containing at least one trigger. The client device decodes the encoded broadcast video stream and parses the broadcast video stream for triggers. As the broadcast video stream is parsed, the stream is output to a display device. When a trigger is identified, the client device automatically tunes to an interactive content channel. The client device sends a signal indicative of the trigger through the television communication network to the processing office. The processing office can then use the information contained within the trigger signal to provide content to the client device. The content may be interactive content, static content, or the broadcast program stitched with interactive or static content. The user of the client device can then interact with any interactive content. In some embodiments, the interactive content may be advertisements.

A user may create a user profile that is stored in memory either at the client device or at the processing office. The user's profile can then be accessed and used to make decisions about the content and the form of the content that is transmitted to the client device. For example, a comparison can be made between the user profile and the trigger information and if they correlate, content related to the trigger information will be provided to the client device.

In other embodiments, the processing office receives the video program that contains the trigger and parses the video program to identify the location of the trigger. Upon identifying a trigger, the processing office can automatically incorporate content into the video program based upon the trigger information. The processing office could send a force signal to each client device that is tuned to the channel for the video program forcing the client device to tune to an interactive channel. The processing office may also access each user's profile that is currently viewing the video program and can then use the profile to determine what content should be transmitted to each client device.

Once the processing office has identified the trigger, a client device, and content, the processing office will stitch together the video program and the new content. In one embodiment, the processing office includes a scaler that scales each frame of the video program. Once the video program is reduced in size, the reduced video program is provided to a stitcher that stitches together the new content and the reduced video program content. Both sources of material, the video content and the new content are in a common format, such as MPEG. The macroblocks of the reduced video content and the new content are stitched together created composite video frames. The new video content may be static information or interactive information created using MPEG objects. For example, the new content may form an L-shape and the reduced video content resides in the remainder of the video frame. The new content need not be present throughout the entire video program and each trigger can identify both new content and also a time period for presentation of the new material.

In embodiments of the invention, the user profile may contain data indicating that the user wishes to view one or more advertisements in exchange for either a reduced fee or no fee for viewing the video program. The user may also complete survey information in exchange for a reduction in the fee associated with the video program or channel.

In other embodiments, a session is first established between the processing office and each active client device within the television communication network. The processing office receives the video program from a content provider and the processing office parses the video program in order to identify one or more triggers. When a trigger is identified, the processing office analyzes the trigger to see if the trigger applies to all viewers or to users that have indicated in their personal profile that they wish to receive content related to the trigger. If the trigger applies to all viewers, the processing office will retrieve the new content associated with the trigger, scale the video program, stitch the video program and new content, and transmit the stitched video program to the client devices that are presently operative and tuned to the video program. If the trigger applies to selected viewers, the processing office will retrieve the personal profile associated with each client device that is in communication with the processing office and tuned to the channel associated with the video program. The processing office will then do a comparison with the profile information and the trigger; and if there is a correlation, the processing office will transmit the video program with the new content stitched into the video program to the client device associated with the user profile.

### BRIEF DESCRIPTION OF THE DRAWINGS

The foregoing features of the invention will be more readily understood by reference to the following detailed description, taken with reference to the accompanying drawings, in which:

FIG. 1 graphically shows an example of an atomic MPEG object as used in a client/server environment;

FIG. 1A is a flow chart showing process flow between a stitcher and events from a client device;

FIG. 2 graphically shows an example of a streaming MPEG object as used in a client/server environment;

FIG. 2A graphically shows an embodiment employing several session processors;

FIG. 3 provides an exemplary data structure and pseudo code for an atomic MPEG button object;

FIG. 4 provides an exemplary data structure and pseudo code for a progress bar MPEG object;

FIG. 5 shows an exemplary screen shot of an authoring environment for creating applications that use MPEG objects;

FIG. 6A shows an exemplary screen shot of a properties tab for an MPEG object;

FIG. 6B shows an exemplary screen shot of an event tab for an MPEG object;

FIG. 6C shows an exemplary screen shot of a script editor that can be used to create a script for an application that uses MPEG objects; and

FIG. 6D shows a system for using MPEG objects for interactive content.

FIG. 7 shows an environment for using triggers designating additional content to be stitched into a video program;

FIG. 7A shows an environment in which a trigger causes a switch in networks;

FIG. 8 is a flow chart directed to the identification of a trigger at a client device; and

FIG. 9 is a flow chart directed to the identification of a trigger at a processing office.

### DETAILED DESCRIPTION OF SPECIFIC EMBODIMENTS

Embodiments of the present invention disclose MPEG objects and systems and methods of using MPEG objects in a client/server environment for providing interactive encoded video content to a client device that includes an MPEG decoder and an upstream data connection to the server in an interactive communications network. As used in the detailed description and the claims the term MPEG element and MPEG video element shall refer to graphical information that has been formatted according to an MPEG standard (Motion Picture Experts Group). The graphical information may only be partially encoded. For example, graphical information that has been transform coded using the discrete cosine transform will be considered to be an MPEG element without requiring quantization, entropy encoding and additional MPEG formatting. MPEG elements may include MPEG header information for macroblocks and the slice level. An MPEG element may include data for either a full MPEG video frame, a portion of an MPEG video frame (macroblocks or slices) that are contiguous or non-contiguous, or data representative of a temporal sequence (frames, macroblocks or slices).

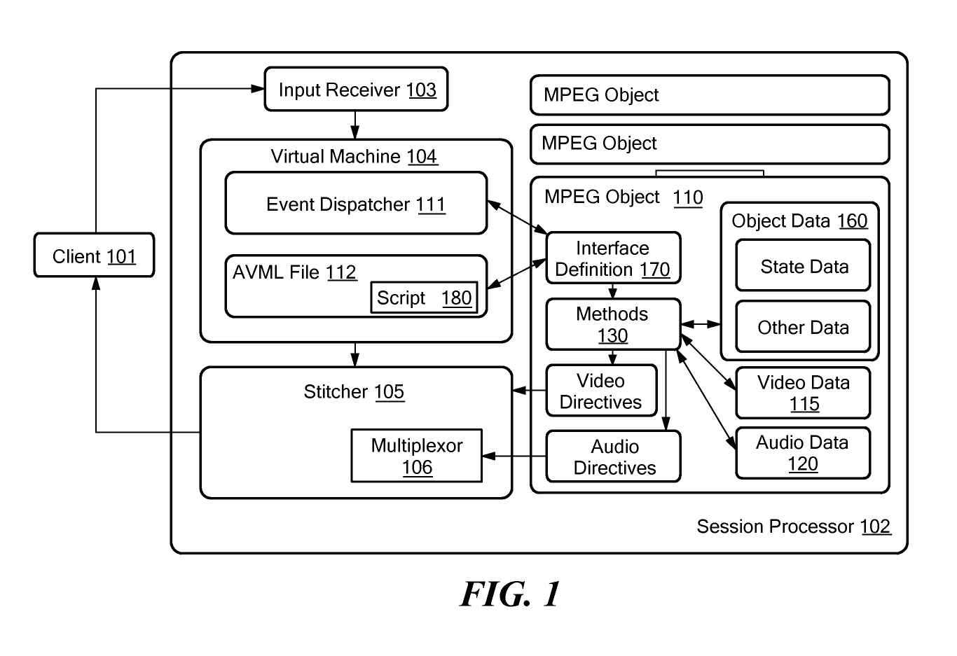

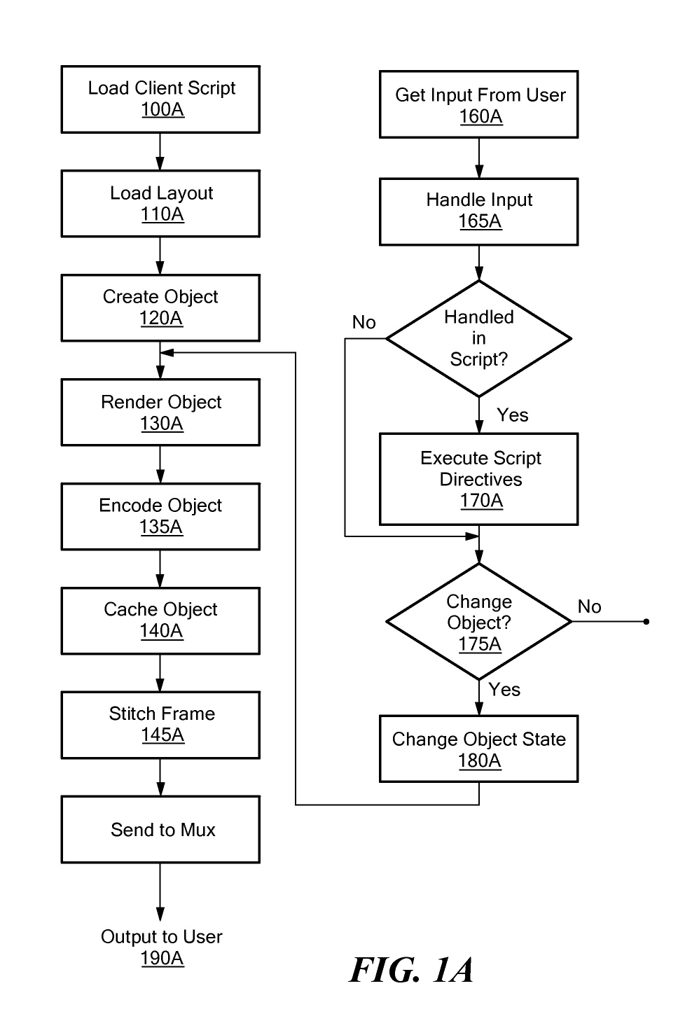

Interactive content formed from MPEG objects is preferably used in a client/server environment 100 as shown in FIG. 1 wherein the client device 101 does not need memory for caching data and includes a standard MPEG video decoder. An example of such a client device is a set-top box or other terminal that includes an MPEG decoder. Client devices may include a full processor and memory for caching; however these elements are not necessary for operation of this system. The server device in the client/server environment contains at least a session processor 102 formed from at least one processor that includes associated memory.

The client 101 and server establish an interactive session wherein the client device 101 transmits a request for an interactive session through an interactive communication network. The server assigns a session processor 102 and the request is sent to an input receiver 103 of the assigned session processor 102. The session processor 102 runs a virtual machine 104 that can interpret scripts. The virtual machine 104 may be any one of a number of virtual machines, such as a JAVA virtual machine. In response to the interactive request from the client, addressing information for the session processor is passed to the client 101. The client 101 then selects an interactive application, as defined in an AVML (Active Video Mark-up Language) file to view and interact with. Interactive applications may include references to video content along with selection controls, such as buttons, lists, and menus. Further explanation of such applications is explained in the U.S. patent application Ser. No. 12/008,697 entitled “Interactive Encoded Content System including Object Models for Viewing on a Remote Device” and assigned to the same assignee, which is incorporated by reference in its entirety. The request for the selected application is directed to the virtual machine 104. The virtual machine 104 accesses the AVML file defining the application that indicates the MPEG objects, along with any other graphical content that is necessary for composing a video frame within a video sequence for display on a display device. The AVML file also includes the location within the frame for positioning each of the MPEG objects. In addition, the AVML file may include one or more scripts. One use for a script is to maintain the state of an MPEG object. These MPEG objects can reside and be accessed at different locations and may be distributed. The graphical elements of the MPEG objects are stitched together by a stitcher 105 based upon the location information within the application file (AVML file) to form complete MPEG video frames. The video frames along with MPEG audio frames are multiplexed together in a multiplexor 106 within the stitcher to form an MPEG stream that is sent to the requesting client device. The MPEG stream may then be decoded and displayed on the client's device. The input receiver, virtual machine, and stitcher may be embodied as either computer code that can be executed/interpreted on the session processor or may embodied in hardware or a combination of hardware and software. In some embodiments, any of the software (i.e. input receiver, virtual machine, or stitcher) may be constructed in hardware that is separate from the session processor. Additionally, the stitcher, which may be a computer program application may incorporate the functionality of the input receiver, the virtual machine and may process and parse the application file (AVML).

In certain embodiments, the stitcher may stitch the graphical elements together based upon the type of device that has requested the application. Devices have different capabilities. For example MPEG decoders on certain devices may not be as robust and capable of implementing all aspects of the chosen MPEG standard. Additionally, the bandwidth of the transmission path between the multiplexor and the client device may vary. For example, in general, wireless devices may have less bandwidth than wireline devices. Thus, the stitcher may insert into the MPEG header parameters a load delay or no delay, allow skips or not allow skips, force all frames to be encoded as I-frames or use a repeated uniform quantization to reduce the number of bits required to represent the values.

An MPEG object is part of a programming paradigm that allows individual MPEG video elements to be stitched together to form a frame of a video stream that incorporates active elements wherein a client can interact with the active elements and more specifically change the video stream. The MPEG video elements associated with an MPEG object may be a plurality of encoded macroblocks or slices that form a graphical element. A client can use a client device to select a graphical element on a display screen and interact with that graphical element. An MPEG object 110 includes an association with MPEG video and/or audio data along with methods and properties for the object. The MPEG video or audio may reside internal to the MPEG object or may be externally accessed through remote function calls. The methods within an MPEG object are code that may receive data from outside of the object, process the received data and/or the MPEG video 115 and audio data 120 and output data from the object according to video and audio directives. Object data 160 may indicate the state of the object or other internal variables for the object. For example, parameters such as display priority may be used to determine the priority of stacked media. In addition, parental control parameters, such as a content rating, may be associated with the audio or video data or an audio or video source or address. A parental control may be a method internal to an MPEG object that provides for control over access to the content.

As shown in FIG. 1, a virtual machine is made active on a session processor 102 in response to a request for an interactive application (AVML file having a script) and accesses a first MPEG object 110 which is an atomic object. An atomic object is self-contained in that the object contains all of the encoded data and methods necessary to construct all of the visual states for the object. Once the object is retrieved by the virtual machine the object requires no additional communications with another source. An example of an atomic object is a button that is displayed within a frame. The button object would have an MPEG video file for all states of the button and would include methods for storing the state based upon a client's interaction. The atomic object includes both pre-encoded MPEG data (video and audio data) 115, 120 along with methods 130. In certain embodiments, the audio or video data may not initially be MPEG elements, but rather graphical or audio data in another format that is converted either by the virtual machine or the stitcher into MPEG elements. In addition to the pre-encoded MPEG data 115, 120, the atomic object can include object data 160, such as state information. The object interacts with external sources through an interface definition 170 along with a script 180 for directing data to and from the object. The interface 170 may be for interacting with C++ code, Java Script or binary machine code. For example, the interface may be embodied in class definitions.

An event may be received from a client device into the input receiver 103 that passes the event to an event dispatcher 111. The event dispatcher 111 identifies an MPEG object within the AVML file that is capable of processing the event. The event dispatcher then communicates the event to that object.

In response, the MPEG object through the interface definition 170 accesses the MPEG video 115 and/or audio data 120. The MPEG object may implement a method 130 for handling the event. In other embodiments, the interface definitions may directly access the data (object data, audio data and video data) Each MPEG object may include multiple MPEG video files that relate to different states of the object wherein the state is stored as object data 160. For example, the method may include a pointer that points the stitcher to the current frame and that is updated each time the stitcher is provided with a video frame. Similarly, the MPEG audio data 120 may have associated methods within the MPEG object. For example, the audio methods 130 may synchronize the MPEG audio data 120 with the MPEG video data 115. In other embodiments, state information is contained within the AVML file 11.

The process flow for the MPEG object and system for implementing the MPEG object is shown in the flow chart of FIG. 1A. In FIG. 1A, all code for accessing and parsing of an application is contained within the stitcher. The stitcher may be a software module that operates within the virtual machine on the session processor.

After receiving the request for the application and retrieving the application the stitcher first loads any script that exists within the application. 100A The stitcher accesses the layout for the video frame and loads this information into memory. 110A The layout will include the background, the overall size of the video frame, the aspect ratio, and position of any objects within the application. The stitcher then instantiates any MPEG objects that are present within the application. 120A Based upon a script within the application that keeps track of the state of an object, the graphical element associated with the state for each object is retrieved from a memory location. The graphical element may be in a format other than MPEG and may not initially be an MPEG element. The stitcher will determine the format of the graphical element. If the graphical element is in a non-MPEG element format, such as a TIFF format, GIF or RGB, for example, the stitcher will render the graphical element into a spatial representation. 130A The stitcher will then encode the spatial representation of the graphical element, so that it becomes an MPEG element. 135A Thus, the MPEG element will have macroblock data formed into slices. If the graphical element associated with the MPEG object is already in an MPEG element format then neither rendering nor encoding is necessary. The MPEG elements may include one or more macroblocks that have associated position information. The stitcher then converts the relative macroblock/slice information into global MPEG video frame locations based upon the position information from the layout and encodes each of the slices. The slices are then stored to memory so that they are cached for quick retrieval. 140A An MPEG video frame is then created. The MPEG elements for each object based upon the layout are placed into scan order by slice for an MPEG frame. The stitcher sequences the slices into the appropriate order to form an MPEG frame. 145A The MPEG video frame is sent to the stitcher's multiplexor and the multiplexor multiplexes the video frame with any audio content. The MPEG video stream that includes the MPEG video frame and any audio content is directed through the interactive communication network to the client device of the user for display on a display device. 190A

Changes to the MPEG frames are event driven. A user through an input device sends a signal through a client device to the session processor that is provided to the stitcher. 160A The stitcher checks to see if the input that is received is input that is handled by the script of the application using the event dispatcher. 165A If it is handled by the script, the script directives are executed/interpreted. 170A The stitcher determines if the object state has changed. 175A The stitcher will retrieve the graphical element associated with the state of that object from a memory location. 180A The stitcher may retrieve the graphical element from a memory location associated with the MPEG object after the event has been processed, or the MPEG object may place the graphical element in a memory location associated with the stitcher during event processing. The stitcher will again determine the format of the graphical element. If the graphical element is in a non-MPEG element format and therefore is not structured according to macroblocks and slices, the stitcher will render and encode the element as an MPEG element and will cache the element into a buffer. 130A, 135A, 140A This new MPEG element representative of the change in state will be stitched into the MPEG frame at the same location as defined by the layout for the MPEG frame from the application. 145A The stitcher will gather all of the MPEG elements and places the slices into scan order and format the frame according to the appropriate MPEG standard. The MPEG frame will then be sent to the client device for display. 190A The system will continue to output MPEG frames into an MPEG stream until the next event causes a change in state and therefore, a change to one or more MPEG elements within the frame layout.

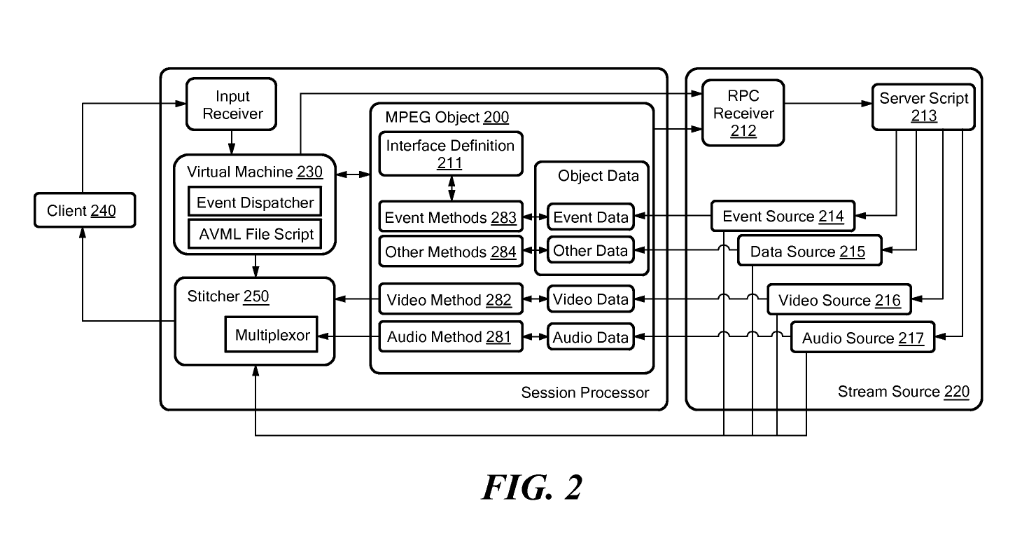

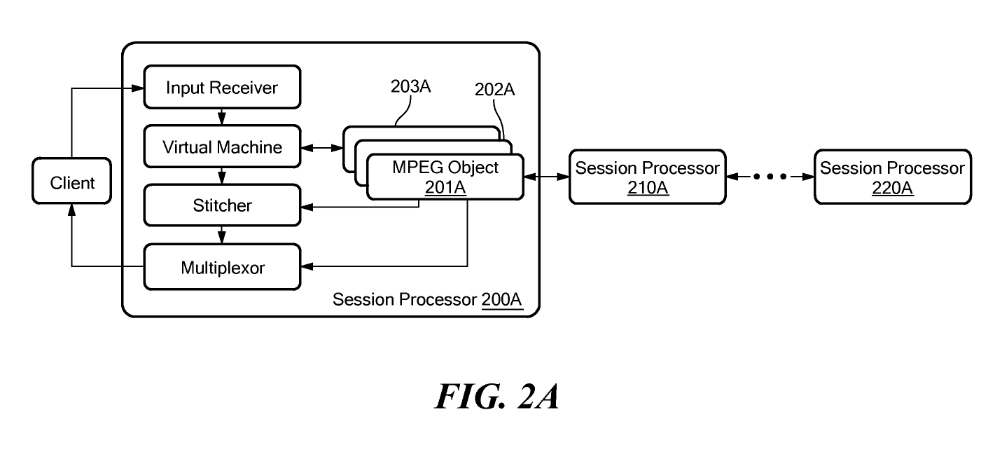

A second MPEG object is a streaming MPEG object. The streaming MPEG object operates within the same environment as the atomic object, but the object is not self-contained and accesses an outside source for source data. For example, the object may be a media player that allows for selection between various sources of audio and video. Thus, the MPEG object is not self-contained for each of the audio and video sources, but the MPEG object accesses the sources based upon requests from the client device. As shown in FIG. 2, the MPEG object 200 and methods implemented according to interface definitions (input, output) 211 link the MPEG object 200 to the virtual machine 230, the stitcher 250, as well as an RPC (remote procedure call) receiver 212 at a stream source 220. Thus, the streaming MPEG object is in communication with the virtual machine/client 230, 240 a stitcher 250, a source entity, the stream source 220 and other sources. The interface definitions may also directly access the data (object, audio and video). In response to an event, an event dispatcher accesses the MPEG object capable of handling the event using the interface. The event dispatcher causes the MPEG object to access or request the video and audio content requested by the client. This request may be achieved directly by a method within the MPEG object that accesses the data source. In other embodiments, a script within the AVML file calls an RPC receiver 212 that accesses a server script 213. The server script 213 retrieves the requested content (event source 214, data source 215, video source 216, or audio source 217) or accesses an address for the content and either provides this information or content to the MPEG object or to the stitcher 250.

The server script 213 may render the requested content and encode the content as one or more MPEG slices. MPEG video content can be passed through the MPEG object to the stitcher 250 that stitches together the MPEG video content into an MPEG video frame. The MPEG object may also request or retrieve audio MPEG content that can be passed to the stitcher. Thus, audio MPEG content may be processed in a similar fashion to MPEG video content. The MPEG video data may be processed by a method within the MPEG object. For example, a method may synchronize all of the MPEG content prior to providing the MPEG content to the stitcher, or the method may confirm that all of the MPEG content has been received and is temporally aligned, so that the stitcher can stitch together a complete MPEG video frame from a plurality of MPEG object video and audio data for presentation to the client in a compliant MPEG stream. The script of the AVML file or the MPEG object may request updated content from the stream source through the server script 213 or directly from an addressable location. An event requesting updated content may originate from communication with the client. The content may originate from a data, audio, video, or event source 214-217.

Event data 214 includes but is not limited to trigger data. Triggers include data that can be inserted into the MPEG transport stream. In addition, triggers may be internal to an MPEG video or audio source. For example, triggers may be located in header information or within the data content itself. These triggers when triggered can cause different events, such as an overlay to be presented on the screen of the client or a pop-up advertisement. The data source 215 may include data that is not traditionally audio or video data. For example, a data from the data source may include an alert notification for the client script, data to be embedded within the MPEG video stream or stock data that is to be merged with a separate graphical element.

Each of the various sources that have been requested is provided to the stitcher directly or may pass through the MPEG object. The MPEG object using a method may combine the data sources into a single stream for transport to the session processor. The single stream is received by the session processor and the session processor like the atomic object the streaming object may include audio and video methods 281, 282 that synchronize the audio and video data. The video method 282 provides the video content to the stitcher so that the stitcher can stitch each of the MPEG video elements together to form a series of MPEG frames. The audio method 281 provides the audio data to the multiplexor within the stitcher so that the audio data is multiplexed together with the video data into an MPEG transport stream. The MPEG object also includes methods 283, 284 for the event data and for the other data.

Steaming MPEG objects may be produced by stitching multiple streaming MPEG objects 201A, 202A . . . 203A together in a session processor 200A. Construction of a scene may occur by linking multiple session processors 210A . . . 220A wherein each session processor feeds the next session processor with the MPEG elements of an MPEG object as shown in FIG. 2A.

The MPEG object, either an atomic object or a streaming object may itself be an application with a hierarchy of internal objects. For example, there may be an application object that defines the type of application at the top level. Below the application object there may be a scene object that defines a user interface including the locations of MPEG elements that are to be stitched together along with reference to other MPEG objects that are necessary for the application. Below the scene object, the individual MPEG object could be located. Thus, an MPEG object may be a self contained application. In such an embodiment, in response to a request for an application, the client script would call the MPEG object that contains the application and the application would be instantiated.

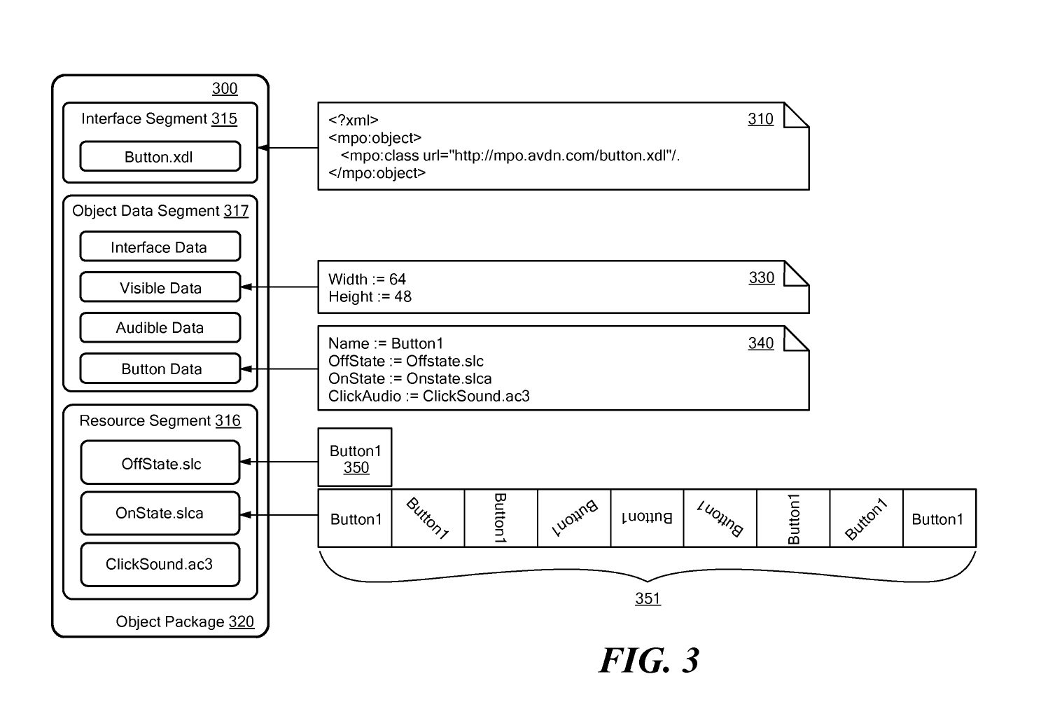

An example of an atomic MPEG object's data structure 300 along with pseudo code 310 for the MPEG object is shown in FIG. 3. Each MPEG object includes an interface segment 315 that may provide such information as class definitions and/or the location of the object and related class definitions in a distributed system. MPEG objects also include either a resource segment 316 or a method for at least receiving one or more resources.

The data structure 300 of FIG. 3 shows the object container/package 320 that includes an interface segment 315 that provides the location of the button MPEG object. The object also includes an object data segment 317. As shown there may be multiple object data segments (i.e. Interface Data, Visible Data, Audible Data, Button Data etc.) The object data is data that is used to define parameters of the object. For example, the visible data 330 for the object defines the height and the width of the button. The button data 340 provides a name for the button along with the states of the button and an audio file that is played when the button is selected (ClickAudio:=ClickSound.ac3). The resource segment 316 of the MPEG button object includes one or more video and/or audio files. In the example that is shown, the various state data for the button are provided 350, 351 wherein the video content would be a collection of macroblocks that represent one or more frames of MPEG video data. Thus, for each state of the button there would be at least one group of MPEG video elements composed of a plurality of macroblocks. The MPEG video elements would be the size of the height and width of the button and may be smaller than a frame to be displayed on a client's display device.

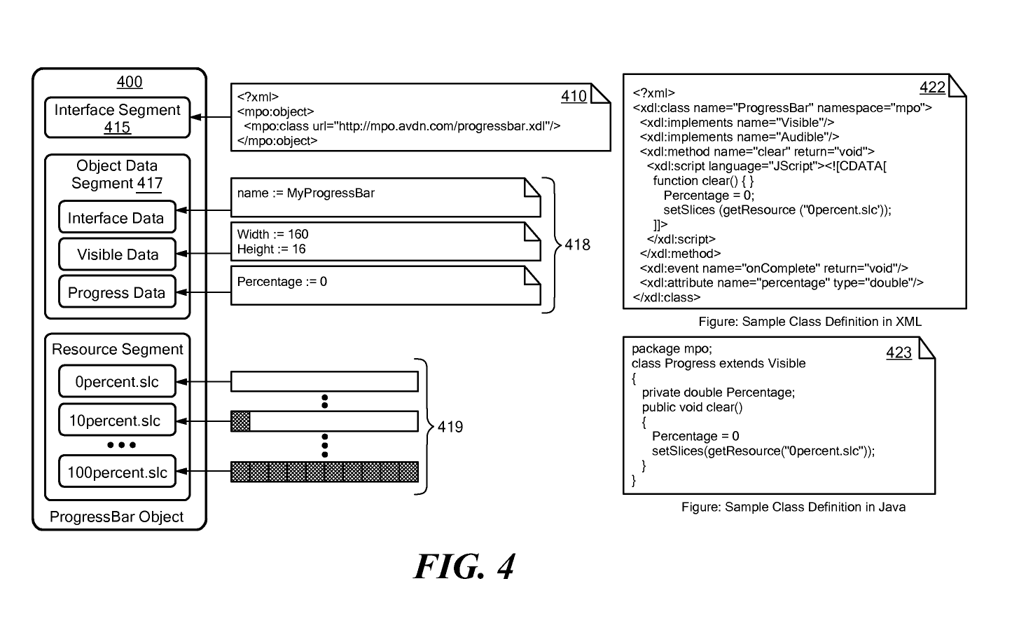

FIG. 4 shows another example of a possible MPEG object including the data structure 400 and pseudo code 410. This example is of a progress bar object. Like the MPEG object of FIG. 3 the progress bar MPEG object includes an interface segment 415 that identifies the location of the object's classes. Sample class definitions are provided in both XML and JAVA 422, 423. In the class definition the class includes methods for clearing the variable percentage and for setting the MPEG graphic initially to 0percent.slc wherein slc represents an MPEG slice. In addition, the progress bar includes an Object Data Segment 417 that provides interface data (name of the progress bar), visible data (the size of the progress bar MPEG slices) and progress data (an internal variable that is updated as progress of the event being measured increases) 418. The progress bar MPEG object includes resource data 316 that includes MPEG slices that represent the various graphical states representing percentages of completion of the event being monitored. Thus, there may be ten different progress bar graphics each composed of MPEG slices 419. These MPEG slices can be combined with other MPEG slices to form a complete MPEG frame.

An authoring environment provides for the creation and manipulation of MPEG objects and allows for the creation of scenes for an interactive application. The authoring environment is preferably a graphical user interface authoring tool for creating MPEG objects and interactive applications by graphical selection of MPEG objects. The authoring environment includes two interfaces. The first interface is the authoring tool for creating MPEG objects and defining application scenes. The second interface is a script editor that allows a designer to add events and methods to MPEG object or to a scene. The output of the authoring environment may be self contained binary code for an MPEG object or a structured data file representing an application. The structured data file for an application includes information regarding the MPEG objects within a scene, the location of the MPEG graphical element of the MPEG object within a frame, properties for the MPEG object, the address/memory location of the MPEG object, and scripts for the application that access and use the MPEG objects. The self contained binary code for an MPEG object may be used by an application. The application may access an MPEG object by referencing the memory location wherein the self-contained binary code is located.

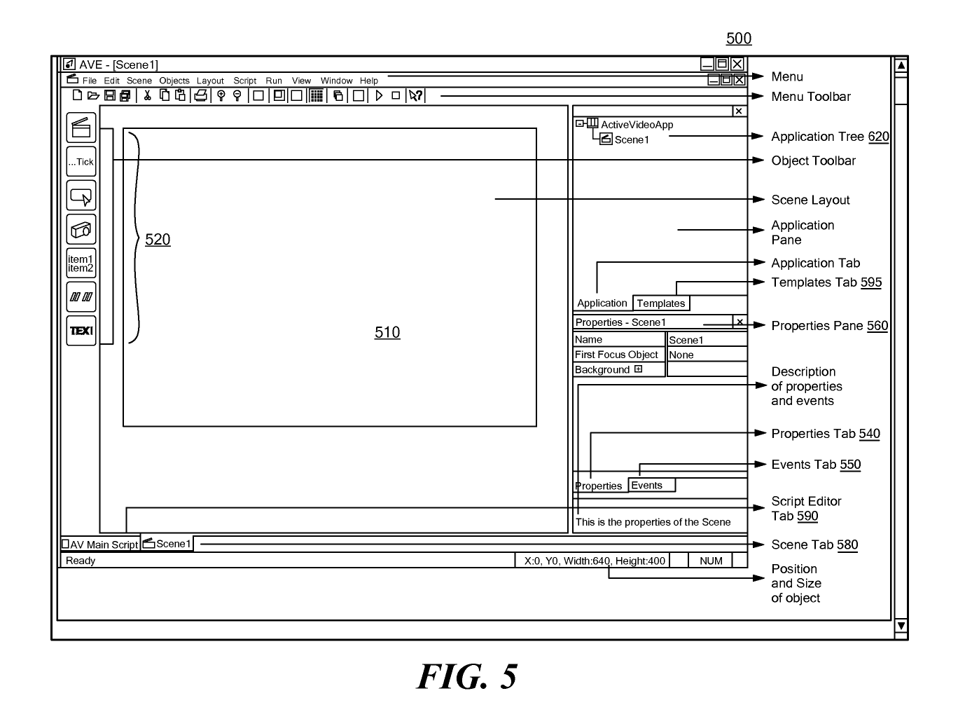

FIG. 5 graphically shows the authoring environment 500. The graphical environment allows an application designer to add MPEG objects into a scene layout 510 though graphical selection of a representative icon 520 that is linked to the underlying object code. In addition, the authoring environment allows a user to create new MPEG objects.

A top level scene will be the first scene that is provided to a user's device when the application is loaded. The application designer can select and drag and drop an object from the object toolbar 520. For example, the designer can insert user interface objects such as: a media player object, a ticker object, a button object, a static image, a list box object, or text. The authoring environment includes other objects such as container objects, session objects and timer objects that are not graphical in nature, but are part of the MPEG object model.

The authoring environment includes an application tree 530 that indicates the level of the application. For example, an application may include a plurality of video scenes wherein a single scene is equivalent to a portion of a webpage. The video scene may allow a user of the interactive video to drill down to a second scene by selecting a link within the video scene. The second scene would be at a level that is lower than the first scene. The application tree 530 provides both a listing of the scene hierarchy as well as a listing of the objects within the scene in a hierarchical order.

Rather than the creation of an application, the designer may create an object or a hierarchical object that contains a plurality of objects. Thus, the output of the authoring environment may also be that of an MPEG object. The designer would provide graphical content, for example in the form of a JPEG image, and the authoring environment would render the JPEG image and encode the JPEG image as a sequence of slices. The authoring environment would also allow the designer to define scripts, methods and properties for the object.

For example, a designer may wish to create a new media player MPEG object to display viewable media streams. The designer may import a graphic that provides a skin for the media player that surrounds the media stream. The graphic would be rendered by the authoring environment and encoded as a plurality of MPEG slices. The designer could then add in properties for the media player object such as the name and location of the media stream, whether a chaser (highlighting of the media stream within the video frame) is present, or the type of highlighting (i.e. yellow ring around the object that has focus). In addition, the designer may include properties that indicate the objects that are located in each direction in case a user decides to move focus from the media player object to another object. For example, there may be a chaser up, down, left, and right properties and associated methods that indicate the object that will receive focus if the current media player object has focus and the user uses a remote control coupled to the user's device (i.e. set-top box) and presses one of the direction keys. The MPEG object designer may provide the media player object with events such as on Load that is triggered every time a user views the scene that has the media player object. Other events may include on Focus that indicates that the object has received focus and on Blur that indicates the object has lost focus. An onKeyPress event may be included indicating that if the object is in focus and a key is pressed that this event will occur. The events and properties for the Media Player Object are provided for exemplary purposes to show the nature and scope of events and properties that can be associated with an MPEG object. Other MPEG objects can be created having similar event and properties as well as distinct events and properties as required by the application designer.

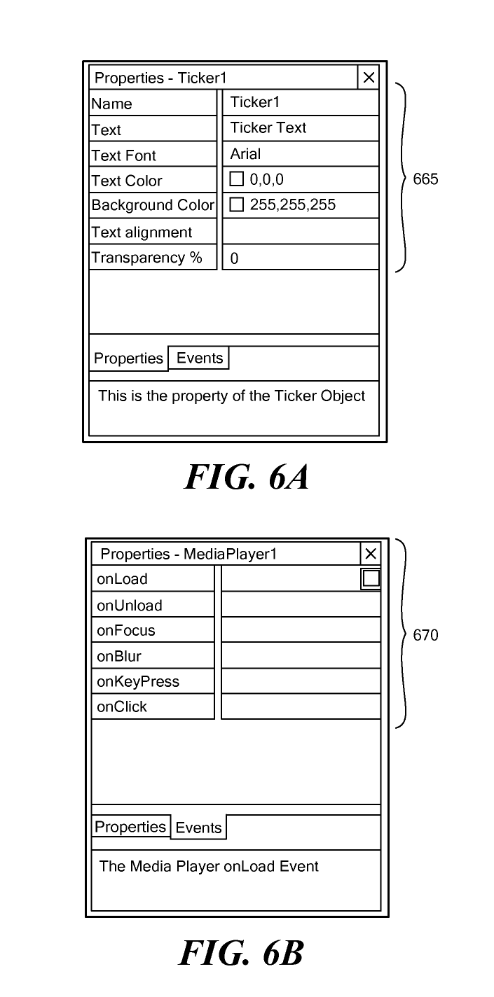

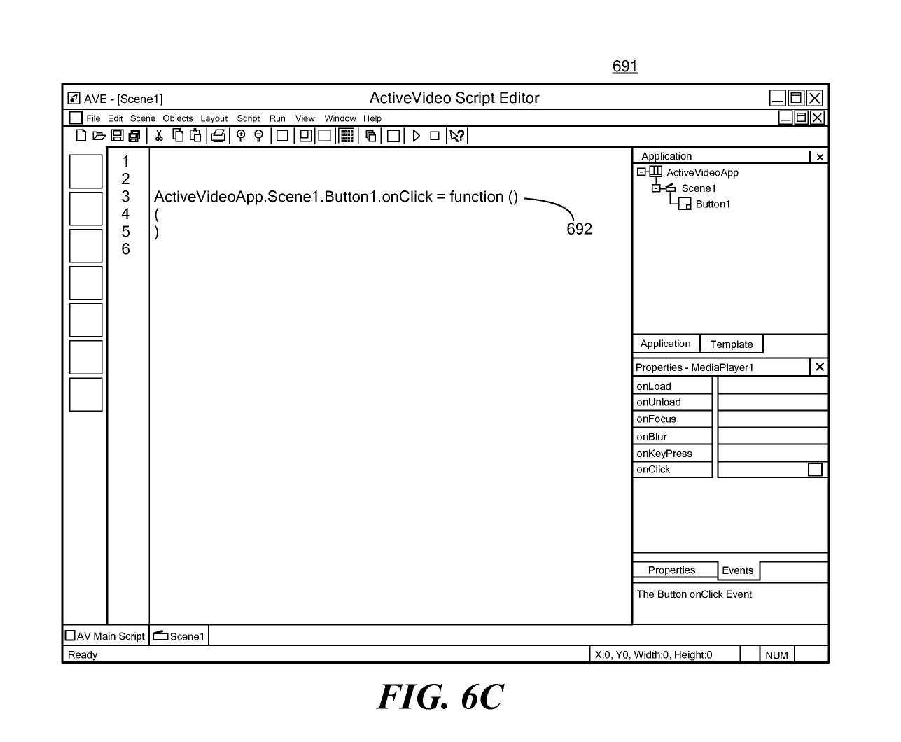

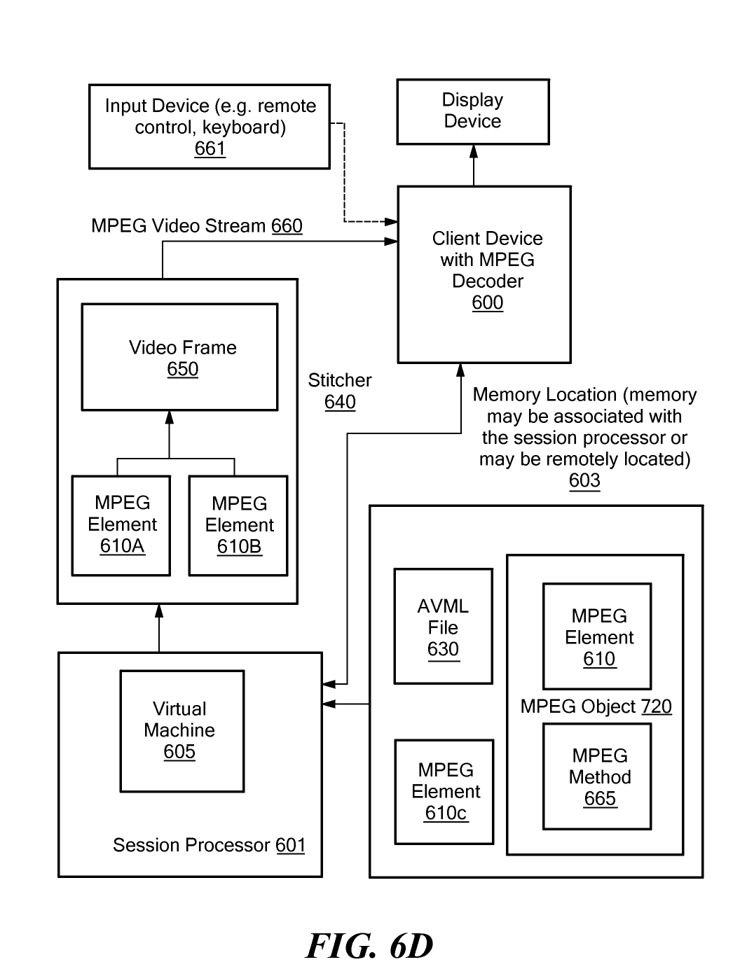

The authoring environment includes a properties 540 and event tab 550 for defining the properties of a predefined or new object. An example of the properties pane 660 is shown in FIG. 6A. The properties for a predefined ticker object (a banner that appears to scroll across the video frame) includes the background color, the text color, the text font and the transparency of the ticker 665. It should be recognized that each object type will have different properties. The events tab allows the application designer to make associations between events (received signals from the user) and the object. For example, a button object may include a plurality of states (on and off). Associated with each state may be a separate MPEG video sequence. Thus, there is a video graphic for the “on” state that indicates the button has been activated and a video graphic for the “off” state that indicates the button is inactive. The event tab allows the application designer to make the association between the signal received from the user, the state change of the object and the change in the video content that is part of the scene. FIG. 6B shows an example of the event tab when selected for a predefined media player object. The events include an on Load, on Focus, on Blur, onKeyPress, and onClick events 670 for the media player. The authoring environment allows the designer to tab between scenes 680 and tab between the scene layout and the scripting page 690. As shown, the authoring environment includes a template tab. The template tab 695 allows for selection of previously saved scenes, so that a designer can use design information from previous scenes for the creation of new scenes. In addition, the designer may be provided with blank event panes and properties panes so that the designer can create a new MPEG object defining properties and events for the new object.

Scripts can be added to an application or to a newly created object by selecting the scripting tab. FIG. 6C shows the script editor 691. For example, the script may determine the function that is provided if a client attempts to select a button graphic 692. In this example, the script would be part of the application file. Similarly, the designer may designate that the script is to be used for creating a script internal to the MPEG object such as the client script within the MPEG streaming object shown in FIG. 2 or the script shown in the atomic object of FIG. 1.

MPEG objects may also be generated in real-time. In this paradigm, a request for an MPEG object is made to the session processor wherein the MPEG object has undefined video and/or audio content. A script at the session processor will cause a separate processor/server to obtain and render the video content for the object, encode the content as an MPEG element and return a complete MPEG object in real-time to the session processor. The server may construct either an atomic or streaming MPEG object. The server may also employee caching techniques to store the newly defined MPEG objects for subsequent MPEG object requests. This methodology is useful for distributed rendering of user specific or real-time generated content. For example, the server may act as a proxy that transcodes a client's photo album where the photos originate in a JPEG format and the server stores the photos as MPEG elements within an MPEG photo album object. The server may then pass the MPEG photo album object to the session processor for use with the requested application. Additionally, the MPEG photo album object would be saved for later retrieval when the client again requests the photo album.

Once the designer has completed the design of the application or the MPEG object, the system takes the received information and converts the information into either binary code if a new MPEG object is created or an AVML (active video mark-up language) file if the designer has created a new application. The AVML file is XML based in syntax, but contain specific structures relevant to the formation of an interactive video. For example, the AVML file can contain scripts that interact with MPEG objects. An explanation of the AVML language can be found in Appendix A attached to U.S. patent application Ser. No. 12/008,697 entitled, “Interactive Encoded Content System including Object Models for Viewing on a Remote Device” filed on Jan. 11, 2008 and assigned to the same assignee, which is incorporated by reference in its entirety. All objects within an application scene have a hierarchy in a logical stack. The hierarchy is assigned based on the sequence of adding the object in the scene. The object first added to the scene is at the bottom of the stack. Objects may be moved up or down within the hierarchy prior to completion of the design and conversion of the graphical scene into the AVML file format. New MPEG objects that are in binary code may be incorporated into applications by referencing the storage location for the binary code.

The AVML file output from the authoring environment allows a stitcher module to be aware of the desired output slice configuration from the plurality of MPEG elements associated with the MPEG objects referenced within the AVML file. The AVML file indicates the size of the slices and the location of the slices within an MPEG frame. In addition, the AVML file describes the encapsulated self-describing object presentations or states of the MPEG objects. For example, if a button object is graphically placed into the authoring environment by a user, the authoring environment will determine the position of the button within an MPEG video frame based upon this dynamic placement. This position information will be translated into a frame location and will be associated with the MPEG button object. State information will also be placed within the AVML file. Thus, the AVML file will list the states for the MPEG button object (on and off) and will have a reference to the location of each MPEG graphical file (MPEG elements) for those two states.

After an application is defined by an application designer, a client can request the application by using the client's device 600 as shown in FIG. 6D. The client's device 600 will request an interactive session and a session processor 601 will be assigned. The session processor 601 will retrieve the AVML file 602 from a memory location 603 for the requested application and will run a virtual machine 605. The virtual machine 605 will parse the AVML file and identify the MPEG objects that the session processor 601 needs to access for the application. The virtual machine 605 will determine the position of each graphical element 610 from the accessed MPEG objects 620 within a video frame based upon the position information from the AVML file 630 and the sizing information as defined within the MPEG objects 620. As shown, only one MPEG object is present in the Fig. although many MPEG objects may be used in conjunction with the AVML file. Additionally, the MPEG object that is shown stored in memory has two representative components, the MPEG element 610 and the MPEG method 665. As expressed above, the MPEG element may be internal to the MPEG object or may be external. The MPEG elements 610a,b, which are preferably MPEG slices from one or more MPEG objects are then passed to the stitcher 640 by the virtual machine 605 and the stitcher sequences the slices so that they form an MPEG video frame 650 according to the position information parsed by the virtual machine. The stitcher is presented with the MPEG elements associated with the objects for each state. For example, if an MPEG button object has MPEG elements of 64×64 pixels and has two states (on and off), the stitcher will buffer the pre-encoded 64×64 pixel MPEG elements for each state.

The MPEG video frame 650 is encapsulated so that it forms a part of an MPEG video stream 760 that is then provided to the client device 600. The client device 600 can then decode the MPEG video stream. The client may then interact with MPEG objects by using an input device 661. The session processor 601 receives the signal form the input device 661 and based on the signal and the object selected methods 665 of the MPEG object 620 will be executed or interpreted by the virtual machine 605 and an MPEG video element 610a will be updated and the updated video element content 610c will be passed to the stitcher 640. Additionally, state information maintained by the session processor for the MPEG object that has been selected will be updated within the application (AVML file). The MPEG video element 610c may already be stored in a buffer within the stitcher. For example, the MPEG element 610c may be representative of a state. A request for change in state of a button may be received by the session processor and the stitcher can access the buffer that contains the MPEG slices of the MPEG element for the ‘off-state’ assuming the button was previously in the ‘on-state.’ The stitcher 640 can then replace the MPEG element slice 610a within the MPEG frame 650 and the updated MPEG frame 650a will be sent to the client device 600. Thus, the client interacts with the MPEG content even though the client device may only have an MPEG decoder and an upstream connection for sending signals/instructions to the assigned session processor 601.

The authoring environment can be used to add digital triggers to content. For example, a broadcast program could be encoded to include either within the actual video program data or in a header a trigger. Thus, the trigger is inband. A trigger is an identifier of a particular condition and can be issued to signal either the processing office or the client device to perform a function. The SCTE 35 ANSI standard includes a discussion of triggers. As used herein, triggers are digital representations. A trigger may be embedded within an elementary stream header or at the transport layer. Triggers as used with the active video network, AVML files, MPEG objects and a stitching module, can achieve new interactions that are not contemplated by the SCTE 35 ANSI standard.

For example, the interaction model can be altered when a trigger is encountered. Key strokes from a user input device associated with a client device may be interpreted differently than normal. The keys may be reassigned in response to a trigger event, allowing for new or different functionality to become available. A trigger encountered in a video stream may cause either a processing office or the client device that identifies the trigger to contact another device. For example, the client device may identify a trigger within the program stream and may interact with a digital video recorder to automatically record the program. In such an embodiment, the trigger may include identification of subject matter and the client device may include a personal profile of the user. Based upon a comparison of the profile and the identified subject matter within the trigger, the client device will cause the broadcast program to be recorded on the digital video recorder, without interaction by a user. In other embodiments, the trigger may cause the program to be redirected to a different device. For example, a trigger within the broadcast stream identified by the processing office may cause a broadcast program to be redirected to a remote device. A user may have a profile located at the processing office that indicates that a program meeting criteria set should be directed to a cell phone, personal digital assistant, or some other networked device. After identifying the trigger within the content, the processing office would compare the user profile with the trigger information and based upon a match between the two, the program content may be forwarded to the networked device as opposed to the client device located at the client's home. One may imagine that the content may not be a broadcast program, but rather another form of content e.g. an article, an image, a stored video program.

In the authoring environment, a content creator can select a video program and can then identify one or more locations for digital triggers within the video program. For example, triggers could be located at the beginning of a program. In such a configuration, the trigger could apply to the entire video program. The triggers may also be located at other locations within the video program stream. For example, the triggers may be located at pre-determined temporal intervals or at transition points within the broadcast. Additionally, after creation of the content, a third party may insert triggers into the content. For example, content from a broadcast source, such as a television network, may have triggers inserted into the broadcast source by a cable provider. The cable provider may insert the triggers into the content based upon some criteria set. For example, the triggers may be temporally located adjacent to advertisement locations or the triggers may be temporally spaced at set intervals (e.g. 5 minutes, 10 minutes, 20 minutes etc.) as such, the triggers are synchronized with the content. The triggers are indicative of interactive content and the triggers may cause a client device that receives the content with the triggers to tune or switch to an interactive channel. In certain systems, a trigger may cause the client device to request an interactive session. The request will be received by the processing office and the processing office will assign an interactive processor for providing interactive content.

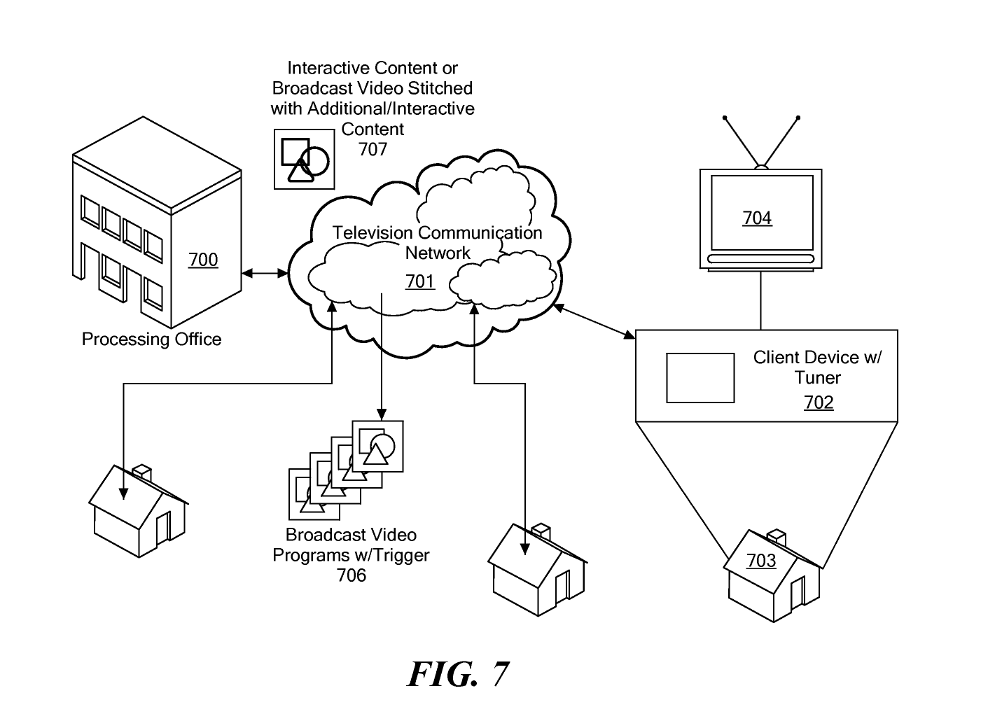

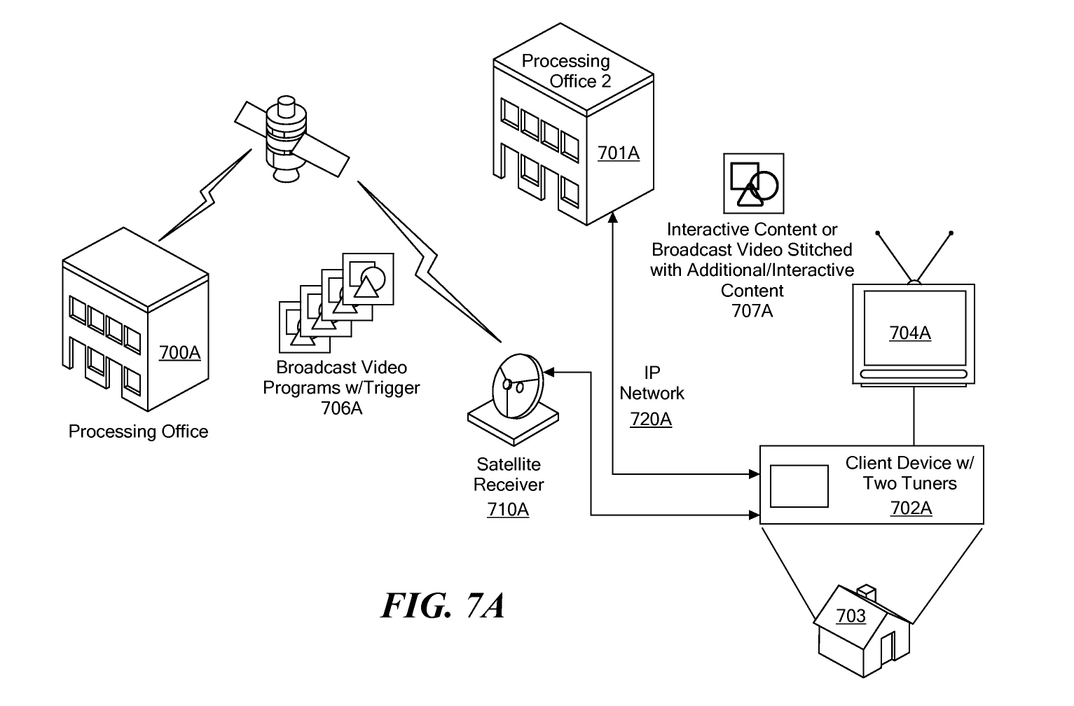

FIG. 7 shows an environment for using triggers. A processing office 700 communicates through a television communication network (e.g. a cable network, fiber optic network, satellite television network) 701 with client devices 702. The client device 702 may be a set-top box that includes a tuner for tuning to one of multiple channels, can decode an encoded television program, and outputs a television signal to a display device 704. Although the client device is shown within a user's house 703, the client device 702 may also be a portable device. In some embodiments, the client device 702 and the display device 704 are a single entity. For example, a cell phone or personal digital assistant (PDA) may include a receiver, decoder and display.

The client device 702 tunes to a channel to receive a broadcast video program 706 or the processing office 700 receives in a broadcast video program that contains triggers either within the broadcast video program data or within an associated header, for example, an MPEG header such as an elementary stream header or a transport stream header. In response to receiving the broadcast data, a processor at the processing office or within the client device parses the video stream and identifies a trigger. Upon identification of a trigger, the processing office 700 will make a transmission to the client device 702 of the user. If the trigger is parsed at the client device 702, the client device will respond by either sending a transmission to the processing office 700 or the client device will cause the tuner within the client device to tune to a designated interactive channel. The client device would then receive interactive content 707 related to the trigger. It should be understood that the term “channel” is being used to indicate a frequency or a protocol for distinguishing between video programs. Digital video programs may be transmitted in parallel wherein each program includes an identifier or “channel” indicator and a client device can receive/tune to the channel that contains the video program. The triggers can be used to activate an interactive session, to cause automatic selection of additional content (either static or interactive) 707, and to include additional information on the display in addition to the broadcast program. Triggers can be associated with an entire program or a portion of a program and triggers can be time limited in duration.

In other embodiments as shown in FIG. 7A, triggers can cause a client device 702A to transmit user input to a separate device. For example, key presses on a user input device may be transferred to another device for interpretation. These key presses could be sent by the client device 702A that receives the key presses to a device that is located on another network. For example, a client device 702A may include or be coupled to a satellite receiver 710A and also an IP internet connection 720A. A satellite processing office 700A transmits content that contains triggers via a satellite. The satellite receiver receives the content with the triggers and the coupled client device 702A recognizes the trigger and then forwards all future key presses through the IP internet connection 720A to the processing office 701A for the IP network 701A. The processing office 701A receives the same broadcast program or has access to the same content as transmitted by the satellite processing office 700A. The processing office 701A can assign a processor and can then add or reformat the broadcast content or provide separate interactive content in response to key presses directed from the client device 702A. In such a manner, interactive content could be made available as a result of a trigger that is received via a one-way satellite transmission.

In some cases, when a trigger is identified by either the client device or by the processing office, the broadcast program provided to the client device and displayed on a display device may not appear to change. However, the video stream producing the broadcast program may now be managed by a different backend infrastructure. Thus, an interactive session is established between the client device and an assigned processor at the processing office. The backend may include a stitching module, such as an MPEG stitching module, that can stitch into the video stream additional content. The processing office may utilize MPEG objects for providing the interactivity within an MPEG video stream as explained above. An end user, may then take advantage of interactive functionality that was not previously available through the broadcast video content stream. It can be imagined, that content can then be pushed to the client device using the interactive session. For example, advertisements may be inserted into the video stream by the assigned processor using a stitching process or an external stitching module. These advertisements may be personalized based upon a profile that is associated with the end user. The advertisements need not be associated with the trigger. For example, a trigger at the beginning of a program (or at any point during a program) would cause an interactive session to occur. The processing office could then insert advertisement at any point subsequent to initiation of the interactive session into the program stream. Thus, the advertisement placement and the trigger are decoupled events.

In other embodiments, the trigger can initiate a new stream that replaces the broadcast content stream. The new stream may contain a picture-in-picture rendition of the original broadcast stream along with other content.

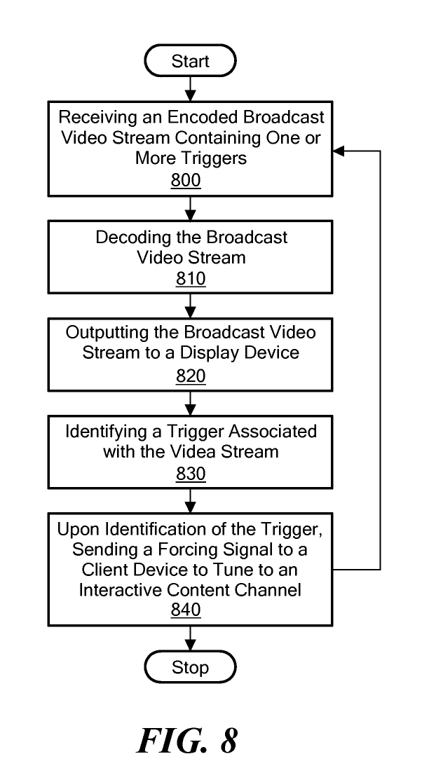

FIG. 8 is a flow chart showing how a trigger can be used by a client device. First an encoded broadcast video stream is received by the client device 800. An encoded video program within the encoded broadcast video stream associated with a tuned channel is decoded by the client device 810. The decoded broadcast video program is output to a display device 820. As the broadcast video program is decoded, a processor parses and searches the broadcast video program to identify any triggers 830. If interactive content is distributed via a specific channel, upon identification of a trigger, the processor of the client device sends a forcing signal to the tuner within the client device, so as to force the client device to an interactive content channel 840. The client device may also send a transmission to the processing office via the television communication network requesting establishment of an interactive session. In alternative embodiments, when a trigger is identified, the client device may send a trigger signal to the processing office. The processing office may then access the user's profile which includes a user's preferences. If the trigger is related to one of the user's preferences, the processing office may establish an interactive session. If the trigger is unrelated to a user's preferences, the processing office will communicate with the client device and the client device will continue to decode and display the video program. In yet still other embodiments, upon identification of a trigger, a client device may send a trigger signal to the processing office that indicates content that should be combined with or stitched into the video program that is being displayed on the user's display device. Again, the additional content may be either static or interactive.

If an interactive session is required, the processing office assigns a processor to the client device and establishes the connection between the assigned processing office processor and the client device. The processing office provides interactive content to the client device and displayed on the user's display device. The interactive content may simply be an MPEG stream wherein MPEG objects are used to define interactive elements and the processing office identifies the relative locations of the interactive elements. The interactive content may be based solely on the trigger within the selected video program. For example, a user may agree to view and provide user feedback in exchange for free viewing of a premium channel. Thus, the user is directed to the interactive content prior to being allowed to view the premium content. If the premium content is broadcast content, a digital video recorder may automatically begin recording the broadcast program while the user interacts with the interactive content. When the user has completed his/her interaction with the interactive content, the client device will either receive a force signal from the processing office or will generate a forcing signal causing the tuner in the client device to tune to the premium channel. If the premium channel is a broadcast, a signal will be sent to the digital video recorder to automatically begin playback of the broadcast program. In such an embodiment as described, the processing office provides the interactive content as full frames of video and the user can not view any of the premium content while operating in the interactive mode. In other variations, the interactive content is merged by the processing office with the premium content/video program. Thus, the user can interact with the interactive content while still viewing the video program. The process of stitching the video program and the interactive content is described in U.S. patent application Ser. No. 12/008,697 filed on Jan. 11, 2008 which is assigned to the same assignee as the present application the content of which is incorporated by reference herein in its entirety. The stitching process is also referenced above in this application.

In other embodiments, the interactive content may be based on personal preferences of the user. For example, the user may create a user profile that indicates that the user wants information regarding a specific baseball player whenever watching a ball game of the player's team. The user of the system may then interact with the provided interactive content. The interactive content, may replace part of the frame of the video content or the video content may be reduced in terms of size (resolution), so that the interactive content may be stitched in a stitcher module with the video program and displayed in the same frame as the video program.

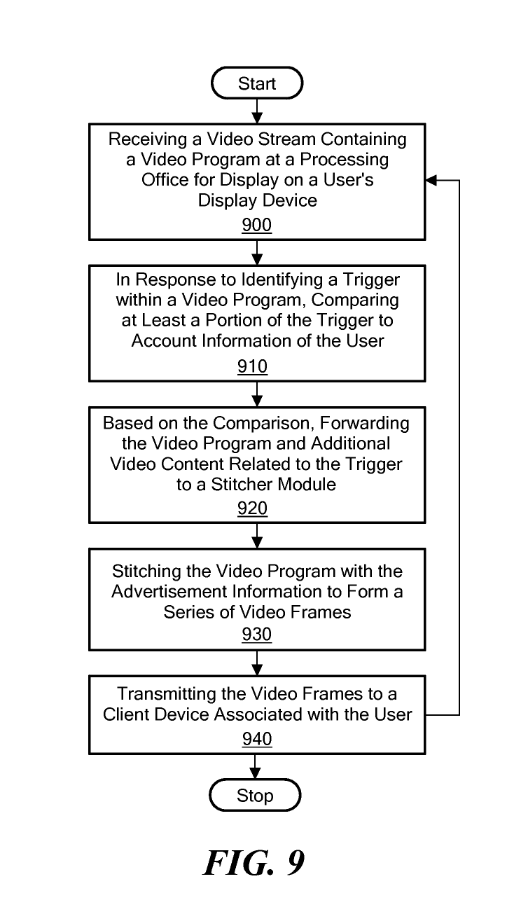

FIG. 9 is a flow chart that describes the process providing interactive content based on a trigger where the processing office identifies the trigger. First, a video stream containing a broadcast video program is received from a video source (i.e. a broadcast television network etc.) 900. The processing office includes a processor that parses the video program to identify triggers within the program 910. For example, a trigger may reside within one or more packet headers or the trigger may reside within the data that represents the video content. When a trigger is identified within a video program, the processing office identifies one or more client devices that are presently in communication with the processing office and are currently decoding the program. This can be accomplished through two-way communications between the client device and the processing office. The processing office accesses a database that contains user profiles and preferences. The processing office then compares the trigger with the user profiles. If a user's profile correlates with the trigger, the processing office will obtain additional video content 920. The video content may be interactive content or static content. The processing office will then stitch the additional video content with the video program using a stitcher module 930. The stitcher module may simply insert frames of the additional video content in between frames of the video program. For example, if the additional video content is an advertisement, the advertisement may be inserted within the video program just prior to an MPEG I frame. In other embodiments, the video program may be provided to a scaler module that will reduce the resolution of the video program. The reduced video program and the additional material are provided to a stitcher and the stitcher stitches the reduced video program and the additional video content into a series of video frames. In this embodiment, the client device does not need to recognize a trigger. In fact, the triggers can be stripped from the video stream and the client device may simply receive an MPEG video stream that can be decoded by a decoder that is compliant with the MPEG specification. The video stream that includes the additional video content and the video program is then transmitted by the processing office through the communication network to each client device having an associated correlated user profile 940. Thus, if a user is tuned to a channel and the user's profile correlates with the trigger, then the video program with the included additional video will be transmitted to the client device of that user. In such an embodiment, multiple client devices may receive the same video stream with the additional video content stitched into the video program. In other embodiments, all client devices that are tuned to a particular channel may receive the video stream with the additional video content stitched into the video program without accessing user profiles. For example, a local advertisement could be stitched into a national broadcast by the inclusion of a trigger within the video program.

Although the present invention has been described in terms of MPEG encoding, the invention may be employed with other block based encoding techniques for creating objects that are specific to those block based encoding techniques. The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

While the invention has been particularly shown and described with reference to specific embodiments, it will be understood by those skilled in the art that various changes in form and detail may be made therein without departing from the spirit and scope of the invention as defined by the appended clauses. As will be apparent to those skilled in the art, techniques described above for panoramas may be applied to images that have been captured as non-panoramic images, and vice versa.

Embodiments of the present invention may be described, without limitation, by the following clauses. While these embodiments have been described in the clauses by process steps, an apparatus comprising a computer with associated display capable of executing the process steps in the clauses below is also included in the present invention. Likewise, a computer program product including computer executable instructions for executing the process steps in the clauses below and stored on a computer readable medium is included within the present invention.

What is claimed is:

1. A method for initiating access to interactive content on a client device coupled to a television communication network, the method comprising:
receiving an encoded broadcast video stream containing at least one trigger from the television communication network into the client device;
decoding the broadcast video stream;
outputting the broadcast video stream to a display device;
identifying the trigger; and
upon identification of the trigger, forcing the client device to tune to an interactive content channel.

2. A method according to claim 1 further comprising:
sending from the client device a signal indicative of the trigger through the television communication network.

3. A method according to claim 1, further comprising:
receiving interactive content related to the trigger at the client device;
decoding the interactive content; and
outputting the interactive content to a display device.

4. A method according to claim 1 wherein the interactive content is an advertisement.

5. A method according to claim 1, further comprising:
storing in memory one or more content identifiers for a user;
receiving an encoded broadcast video stream containing at least one trigger from the television communication network into the client device;
decoding the broadcast video stream;
outputting the broadcast video stream on a first channel;
identifying a trigger within the broadcast video stream
comparing a content identifier to the identified trigger;
if the content identifier and the identified trigger match, tuning the client device to an interactive channel.

6. A method according to claim 5 wherein the content identifiers are stored at a processing office within the television communication network.

7. A method for initiating access to video content on a client device coupled to a television communication network, the method comprising:
receiving an encoded broadcast video program stream containing at least one trigger from the television communication network into the client device;
decoding the broadcast video program stream;
outputting the broadcast video program to a display device;
identifying the trigger;
upon identification of the trigger, sending a trigger signal to a processing office; and receiving a new video stream including the broadcast video program stitched with additional content related to the trigger.

8. A method according to claim 7 further comprising:
reducing the resolution of the video program;
wherein the additional content is stitched into a plurality of video frames that also contain the reduced video program.

9. A method according to claim 7 wherein the additional content is an advertisement.

10. A method according to claim 7 wherein the additional content is interactive content.

9. A method according to claim 7 wherein the user's account information indicates that the user wishes to view advertisements for programs identified by the user in exchange for not paying additional fees for the video program.

10. A method according to claim 8 wherein reducing the resolution comprises reducing the resolution of the video program wherein reducing the resolution comprises eliminating data from the video program

11. A method according to claim 8 wherein the video program is encoded as MPEG video and wherein each video frame is an MPEG video frame.

12. A method for providing interactive content to a client device of a user, the method comprising:
establishing a session at a processing office between the client device of the user and the processing office;
receiving a video stream containing a broadcast video program at the processing office, the video stream including one or more triggers; and
sending in response to identification of a trigger a signal to the client device of the user causing the client device to tune to an interactive channel.

13. A method according to claim 12, further comprising:
accessing account information for a user;
wherein sending in response to identification of a trigger requires a correspondence between the account information and the trigger.

14. A method for providing interactive content to a client device of a user, the method comprising:
receiving a video stream containing a video program at a processing office, the video stream including one or more triggers;
accessing a user's account information;
based on the user's account information and the one or more triggers, forwarding the video program to a to a stitcher module;
stitching the video program together with additional content related to the one or more triggers to form a series of video frames; and
transmitting the video frames to a client device associated with the user.

15. A method according to claim 14 wherein stitching occurs if the user's account includes an entry indicative of the one or more triggers for the video program.

16. A method according to claim 14, further comprising encoding the video frames into a format compatible with the client device.

17. A method according to claim 14, wherein the format is an MPEG format.

18. A method according to claim 17 wherein the additional content is in an MPEG format.

19. A computer program product having computer code on a computer readable medium for initiating interactive content in a client device coupled to a television communication network, computer code comprising:
computer code for receiving an encoded broadcast video stream containing at least one trigger from the television communication network into the client device;
computer code for decoding the broadcast video stream;
computer code for outputting the broadcast video stream on a first channel;
identifying the trigger; and
computer code for forcing the client device to tune to an interactive content channel upon identification of the trigger.

20. A computer program product according to claim 19 further comprising:
computer code for sending from the client device a signal indicative of the trigger through the television communication network.

21. A computer program product according to claim 19, further comprising:
computer code for receiving interactive content related to the trigger at the client device;
computer code for decoding the interactive content; and
computer code for outputting the interactive content to a display device.

22. A computer program product according to claim 19 wherein the interactive content is an advertisement.

23. A computer program product according to claim 19, further comprising:
computer code for storing in memory one or more content identifiers for a user;
computer code for receiving into the client device from the television communication network an encoded broadcast video stream containing at least one trigger;
computer code for decoding the broadcast video stream;
computer code for outputting the broadcast video stream on a first channel;
computer code for identifying a trigger within the broadcast video stream;
computer code for comparing a content identifier to the identified trigger;
computer code for tuning the client device to an interactive channel if the content identifier and the identified trigger match.

24. A computer program product according to claim 23 wherein the content identifiers are stored at a processing office within the television communication network.

25. A computer program product according to claim 23 wherein the content identifiers are stored within the client device.

26. A computer program product having computer code on a computer readable medium causing a processor to provide a video program to a user, the computer code comprising:
computer code for receiving a video stream containing a video program at a processing office, the video stream including one or more triggers;
computer code for accessing a user's account information in response to identifying a trigger;
computer code for forwarding the video program and advertisement information related to the trigger to a stitcher module based on the user's account information;
computer code for stitching the video program with the advertisement information to form a series of video frames; and
computer code for transmitting the video frames to a client device associated with the user.

27. A computer program product according to claim 26 further comprising:
reducing the resolution of the video program;
wherein the advertisement information is stitched into a plurality of video frames that also contain the reduced video program.

28. A computer program product according to claim 26 wherein the user's account information indicates that the user wishes to view advertisements for programs identified by the user in exchange for not pay additional fees for the video program.

29. A computer program product according to claim 27 wherein reducing the resolution comprises down converting the video program
wherein reducing the resolution comprises eliminating data from the video program

30. A computer program product according to claim 27 wherein the video program is encoded as MPEG video and wherein each video frame is an MPEG video frame.

31. A computer program product having computer code on a computer readable medium causing a processor to provide interactive content to a client device of a user, the method comprising:
computer code for establishing a session at a processing office between the client device of the user and the processing office;
computer code for receiving a video stream containing a broadcast video program at the processing office, the video stream including one or more triggers; and
computer code for sending in response to identification of a trigger a signal to the client device of the user causing the client device to tune to an interactive channel.

32. A computer program product according to claim 31, further comprising:
computer code for accessing account information for a user;
wherein the computer code for sending in response to identification of a trigger requires a correspondence between the account information and the trigger.

33. A computer program product having computer code on a computer readable medium causing a processor to provide interactive content to a client device of a user, the computer code comprising:
computer code for receiving a video stream containing a video program at a processing office, the video stream including one or more triggers;
computer code for accessing a user's account information;
computer code for forwarding the video program to a to a stitcher module based on the user's account information and the one or more triggers;
computer code for stitching the video program together with additional content related to the one or more triggers to form a series of video frames; and
computer code for transmitting the video frames to a client device associated with the user.

34. A computer program product according to claim 14 wherein stitching occurs if the user's account includes an entry indicative of the one or more triggers for the video program.

35. A computer program product according to claim 33, further comprising encoding the video frames into a format compatible with the client device.

36. A computer program product according to claim 33, wherein the format is an MPEG format.

37. A computer program product according to claim 36 wherein the additional content is in an MPEG format.

38. A method for providing a video program to a user, the method comprising:
receiving a video stream containing a video program at a processing office, the video stream including one or more triggers;
in response to identifying a trigger, accessing a user's account information;
based on the user's account information, forwarding the video program and additional content related to the trigger to a stitcher module;
stitching the video program with the advertisement information to form a series of video frames; and
transmitting the video frames to a client device associated with the user.
